(19) United States
(12) Patent Application Publication
(10) Pub. No.: US 2010/0087306 A1
(43) Pub. Date: Apr. 8, 2010

(54) Centrifuging device with a detachable cover and a safeguard structure for prevention of the departure of rotor from it

(75) Inventors: Seongjun Yoon, Seoul (KR); Sanghyeon Kang, Seoul (KR); Jisung Park, Seoul (KR); Youyoung Choe, Suwon-Si (KR); Kyungshik Choi, Suwon-Si (KR); Junghee Kim, Suwon-Si (KR); Sinil Kim, Suwon-si (KR)

Correspondence Address: Ballard Spahr LLP, SUITE 1000, 999 PEACHTREE STREET, ATLANTA, GA, 30309-3915, US

(73) Assignees: iNtRON Biotechnology, Inc., Sungnam-Si (KR); Kinemotion Co., Ltd., Incheon-Si (KR)

(21) Appl. No.: 12/322,019

(22) Filed: Jan. 28, 2009

(30) Foreign Application Priority Data
Oct. 8, 2008 (KR) 10-2008-0098572

(51) Int. Cl. B04B 7/06

(52) U.S. Cl. 494/12

(57) ABSTRACT

Disclosed is a centrifuging device with a detachable cover and a safeguard structure in which the cover of the centrifuging device can be completely separated from the housing; and the safeguard structure can prevent a rotor from becoming separated from a drive shaft during operation due to flange defection and prevent the fractured pieces of the rotor from springing out of the housing when the rotor breaks or cracks. The centrifuging device according to the invention offers ease of cleaning and improved safety. Furthermore, there is no need to worry about the fracture of a coupling portion between the cover and the housing attributable to the repeated opening and closing.

### CROSS REFERENCE TO RELATED APPLICATIONS

This application claims priority to Korean Patent Application No. 10-2008-0098572, filed Oct. 8, 2008, which application is incorporated by this reference in its entirety.

### BACKGROUND OF THE INVENTION

1. Field of the Invention

The present invention relates to a centrifuging device, and more particularly to a centrifuging device with a detachable cover and a safeguard structure in which the cover of the centrifuging device can be completely separated from the housing; and the safeguard structure can prevent a rotor from becoming separated from a drive shaft during operation due to flange defection and prevent a fractured pieces of the rotor from springing out of the housing when the rotor breaks or cracks.

2. Description of the Related Art

Generally, a centrifuging device is used for separating a specified component from a mixture of a variety of components having different densities or phases using centrifugal force.

The centrifuging device primarily includes a housing and a cover. The housing accommodates a cylindrical rotor with a plurality of hollow cavities for receiving sample tubes and a driving unit for rotating the rotor at high speeds. The cover is an element for separating the inside space of the housing (in which the rotating rotor is accommodated) from the outside and is an essential element for preventing a sample (mixture) from flying off and intrusion of external foreign matter into the housing.

A plurality of sample tubes containing a sample to be centrifugally separated are inserted into the hollow cavities in the rotor, and centrifugation starts by rotation of the rotor with sample tubes at a high speed in the housing by the driving unit. Through these steps, the sample contained in each sample tube may be centrifugally separated.

Generally, the cover is directly connected to the housing by a hinge. Accordingly, to insert sample tubes into hollow cavities in the rotor for centrifugal separation and to removing sample tubes from the rotor after a centrifugal separation process is finished, an operator exposes the housing by pivoting the cover.

Conversely, to perform the centrifugal separation, i.e. to rotate the rotor to which the sample tubes are inserted, the operator closes the housing by pivoting the cover about the hinges. By such operations, the inside and outside of the housing is demarcated.

Owing to the cover being connected directly in a fixed manner to the housing, the following problems occur.

Since the cover is fixed to an end of the housing in a pivoting manner, it is difficult to clearly wash the cover. That is, when a sample comes to stick to the surface of the cover or the housing due to the scattering of the leaking sample fluid from the sample tube by centrifugal force, perfect cleaning the housing and the cover is difficult because the cover can not be completely separated from the housing in the known centrifuging device. Above all, it is difficult to perfectly clean the hinge. Accordingly, the centrifuging device may become severely contaminated.

Another problem of the known centrifuging device is that the connection part between the cover and the housing easily becomes broken due to the repeated opening and closing, which results in a shortened lifespan of the centrifuging device.

According to the known centrifuging device, additional connection means capable of cooperating with the hinge manner is needed to securely connect the cover to the housing.

Because the cover cannot be completely separated from the housing due to the hinge, the operator must hold the cover when inserting the sample tubes into or removing the sample tubes from the rotor. It is inconvenient.

The rotor of the centrifuging device may be separated from a drive shaft during operation due to the defection of the flange. Moreover, the fractured pieces of the rotor are likely to spring out of the housing of the centrifuging device in the case when the rotor breaks or cracks. Such accidents actually occur, which bring about a severe dangerous situation. Accordingly, an effort and means for preventing the above safety problems is needed. However, a centrifuging device capable of solving such problems has not been developed yet.

### SUMMARY OF THE INVENTION

The invention is made in view of the above-mentioned problems and an object of the invention is to provide a centrifuging device with a detachable cover and a safeguard structure in which the cover of the centrifuging device can be completely separated from the housing; and the safeguard structure can prevent a rotor from becoming separated from a drive shaft during operation due to flange defection and prevent a fractured pieces of the rotor from springing out of the housing when the rotor breaks or cracks.

According to one aspect of the invention, there is provided a centrifuging device including a housing composed of a lower and middle housing in which a driving unit is accommodated, and an upper housing with a safeguard structure for preventing a rotor from becoming separated from a drive shaft during operation due to flange defection and the fractured pieces of the rotor from springing out of the housing when the rotor breaks or cracks, in which a lower portion of the rotor is installed in a manner such that a lower portion of the rotor can rotate; wherein a rotor with a plurality of hollow cavities for receiving sample tubes; and wherein a cover which is attached to the housing can be completely separated from the housing and separate the rotor from the outside.

In the centrifuging device, it is preferable that the housing be composed of a lower housing and a middle housing accommodating a driving unit therein, and an upper housing accommodating a lower portion of the rotor connected to the drive shaft. The upper housing is composed a ring-shaped metal plane portion capable of preventing the rotor and the fractured pieces of the rotor from springing out of the housing, and the connection part between the upper housing and the middle housing. The ring-shaped metal plane portion extends inward from an inside surface of the upper housing and has an inner diameter smaller than a diameter of the lower portion of the rotor for functioning as a safeguard structure.

In the centrifuging device, it is preferable that a plurality of magnets be fixed to a lower end portion of the cover so that the cover is coupled to the ring-shaped plane portion of the upper housing by magnetic force when the cover is placed on the upper housing. Accordingly, the ring-shaped plane portion must be made of a metal so that the cover and the ring-shaped plane portion can be coupled to each other by the magnetic force.

In the centrifuging device, it is preferable that the upper housing have an extension portion extending upward from an inner edge of the ring-shaped plane portion of the upper housing, in which the extension portion has an internal circumferential surface corresponding to the surface of the rotor and an external circumferential surface corresponding to the internal circumferential surface of the lower end portion of the cover.

In the centrifuging device, it is preferable that the extension of the ring-shaped plane portion of the upper housing have a ring shape extending over the entire length of the inner edge of the ring-shaped plane portion, or be composed of a plurality of unit pieces arranged along the entire length of the inner edge of the ring-shaped plane portion while having a predetermined gap between each of them.

In the centrifuging device, the upper housing provides a safeguard structure which can prevent the rotor and the fractured pieces of the rotor from springing out of the housing. However, this structure is just an embodiment. That is, it is possible to obtain the same advantage by coupling a third part having a safeguard structure to the upper housing.

The centrifuging device according to the invention has advantages in that the cover can be completely separated from the housing so that the cover and the housing can be conveniently washed and has another advantage in that fracture of a coupling portion between the cover and the housing, which frequently occurs in the known centrifuging device attributable to the repeated opening and closing, is not likely to occur.

Further, according to the invention, it is possible to prevent the rotor from becoming separated from the drive shaft during operation due to the defection of the flange, and to prevent the fractured pieces of the rotor from springing out of the housing when the rotor cracks or breaks. Accordingly, the centrifuging device according to the invention offers dramatically improved safety in comparison with the known centrifuging device.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a perspective view illustrating a centrifuging device according to one embodiment of the invention;

FIG. 2 is a sectional view illustrating a housing of the centrifuging device, part of which is cut off according to the embodiment of the invention; and

FIG. 3 is a perspective view illustrating a coupling state of a cover and the housing which constitutes the centrifuging device shown in FIG. 1 and FIG. 2.

### DETAILED DESCRIPTION OF THE INVENTION

Reference will now be made in greater detail to exemplary embodiments of the invention, an example of which is illustrated in the accompanying drawings. Wherever possible, the same reference numerals will be used throughout the drawings and the description to refer to the same or like parts.

Hereinafter, centrifuging devices according to embodiments of the invention will be described with reference to the accompanying drawings.

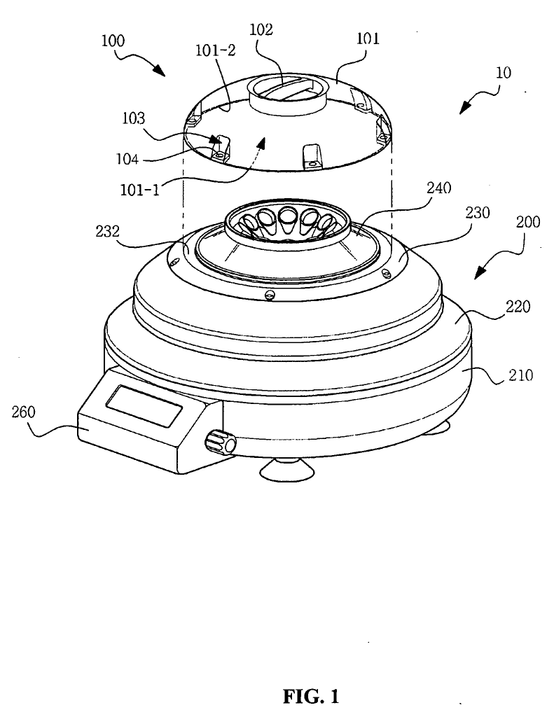

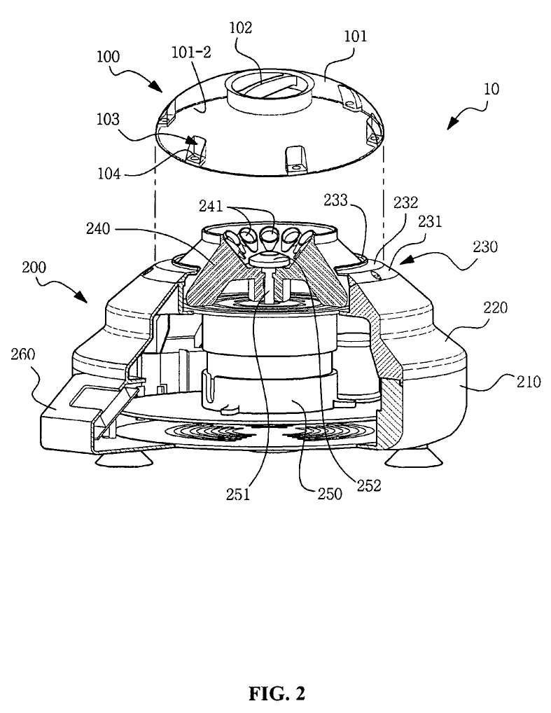

FIG. 1 is a perspective view illustrating a centrifuging device according to one embodiment of the invention, and FIG. 2 is a sectional view illustrating the centrifuging device of FIG. 2, part of which is cut off.

With reference to FIG. 1 and FIG. 2, the centrifuging device 10 according to one embodiment of the invention includes a housing 200 having a hollow body, and a hemispherical cover 100 coupled to an upper portion of the housing 200.

A driving unit 250 and a rotor 240 connected to the drive shaft 251 of the driving unit 250 are installed in the housing 200. The rotor 240 has a conical shape and the center portion of the rotor 240 is connected to the drive shaft 251 of the driving unit 250. The inner circumferential surface of the rotor 240 has a plurality of hollow cavities 241 for receiving sample tubes.

Each of the hollow cavity 241 is a hole having a predetermined depth and can receive a tube (not shown) containing a sample therein.

A reference 252 denotes a flange provided at an upper end portion of the drive shaft 251 and functions to prevent the rotor 240 from becoming separated from the drive shaft 251.

The housing 200 includes a cylindrical lower housing 210, a middle housing 220 connected to the lower housing 210 and having a space for accommodating the driving unit 250 therein, and an upper housing 230 which receives a lower portion of the rotor 240 and is coupled to the cover 100. The upper housing 230 has a safeguard structure which is the feature of the invention. Accordingly, the driving unit 250 is placed in the lower housing 210 and the middle housing 220. Particularly, the lower portion of the rotor 240 is accommodated in the upper housing 230, and an upper portion of the rotor 240 protrudes from an upper end portion of the upper housing 230 through a ring-shaped opening portion and is exposed to air.

The upper housing 230 has a ring-shaped opening external circumferential plane portion 232 which functions as a safeguard structure and has an inner diameter smaller than a diameter of the lower portion of the rotor 240. The upper housing 230 has a connection part 231 for connecting the upper housing 230 to the middle housing 220. The upper housing 230 and the middle housing 220 are connected to each other via the connection part 231. When connecting the upper housing 230 and the middle housing 220 to each other, connecting means, such as a bolt and nut is used, but the connecting means may not be limited thereto. The ring-shaped opening external circumferential plane portion 232 is called a ring-shaped plane portion.

The ring-shaped plane portion 232 which is the safeguard structure of the upper housing 230 and which has a diameter smaller than the diameter of the lower portion of the rotor 240 for preventing the rotor 240 from becoming separated form the drive shaft 251 during operation due to the defection of the flange 252 and for preventing the fractured pieces of the rotor 240 from springing out of the housing 200 of the centrifuging device when the rotor 240 breaks or cracks. The ring-shaped plane portion 232 is a portion at which a lower portion of the cover 100 is placed and at which coupling between the cover 100 and the housing 200 is achieved by the action of magnetism. Accordingly, the ring-shaped plane portion 232 is preferably made of a metal.

The upper housing 230 may further include an extension portion 233 which extends upward from an inner edge of the ring-shaped plane portion 232 in addition to the ring-shaped plane portion 232 and the connection part 231.

The extension portion 233 formed at the inner edge of the ring-shaped plane portion 232 has a predetermined height, and an internal circumferential surface of the ring-shaped plane portion 232 corresponds to an external circumferential surface of the rotor 240. FIG. 2 shows that the ring-shaped extension portion 233 is formed of a single member continuously extending over the entire length of the inner edge of the ring-shaped plane portion 232, but the invention is not limited thereto. For example, the extension portion 233 may be composed of a plurality of unit pieces which is arranged along the entire length of the inner edge of the ring-shaped plane portion 232 with a predetermined gap between each of them.

The cover 100 is composed of a hemispherical elementary part 101 of which a lower end is open, a handle 102 provided at an upper portion of the elementary part 101, and a plurality of magnets 104 installed at a lower end portion of the cover 100. The outer circumferential surface of the lower end of the hemispherical elementary part 101 is provided with a plurality of concave portions 103, each concave portion 103 having a bottom extending inward and sides extending downward. Magnets 104 are fixed to the bottoms of the concave portions 103.

Functions of the centrifuging device composed of the housing 200 including the upper housing 230 having the above-mentioned safeguard structure, along with those of the cover 100, will be described with reference to the drawings.

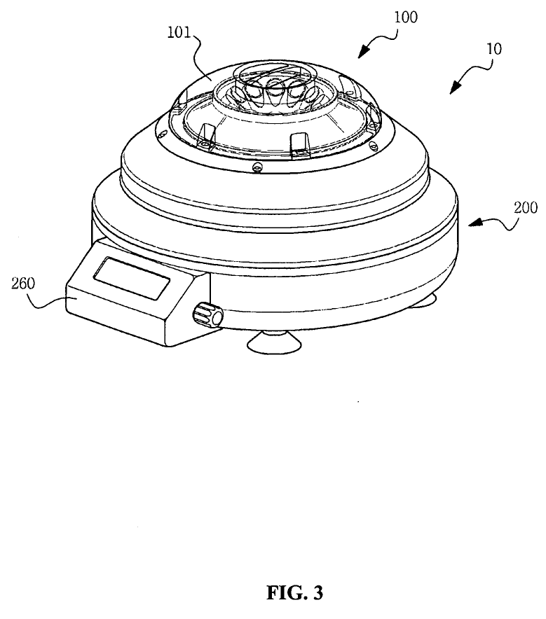

FIG. 3 is a perspective view illustrating a coupling state of a cover 100 and the housing 200 which constitute the centrifuging device shown in FIG. 1 and FIG. 2.

An operator inserts the sample tubes (not shown) into the hollow cavities 241 of the rotor 240 placed in the housing 200 and then places the cover 100 on top of the housing 200.

That is, the lower end portion 101-2 of the hemispherical elementary part 101 of the cover 100 and the bottoms of the concave portions 103 are placed on the ring-shaped plane portion 232 of the upper housing 230, and the cover 100 is attached to the ring-shaped plane portion 232 made of a metal by the magnetic force of the magnets 104 fixed to the bottoms of the concave portions 103.

The operator rotates the rotor 240 by driving the driving unit 250 through a control panel 260 attached to the housing 200. Therefore the samples in the sample tubes inserted in the hollow cavities 241 of the rotor 240 are centrifugally separated by the centrifugal force.

After completion of the centrifugal separation process, the operator can completely separate the cover 100 from the housing 200 (see FIG. 2) by lifting the cover 100 with the force which is stronger than the coupling force between the magnets 104 fixed to the cover 100 and the ring-shaped plane portion 232.

In the state of FIG. 2 in which the cover 100 is completely separated from the housing 200, the operator can easily remove the sample tubes inserted in the hollow cavities 241 of the rotor 240 and insert new sample tubes in the hollow cavities 241 of the rotor 240. Further, it is easy to wash and remove the sample which leaks from the sample tubes during the centrifugal separation process and sticks to the cover 100.

On the other hand, the cover 100 is fixed onto the ring-shaped plane portion 232 of the upper housing 230 only by the magnetic force of the magnets 104. Accordingly, in the case in which unexpected external force stronger than the magnetic force is exerted on the hemispherical cover 100, the cover 100 is likely to shake on the upper housing 230.

In the case in which the cover 100 shakes in a certain direction by the external force occurring in the middle of the centrifugal separation process, i.e. while the rotor 240 is rotating in the upper housing 230, the cover 100 is likely to be brought into contact with the rotor 240, which may severely affect the rotation of the rotor 240 and may cause the cover 100 to break or to be separated from the centrifuging device 10.

To prevent such an accident from occurring, the extension portion 233 having a predetermined height is formed at the inside edge (facing the rotor 240) of the ring-shaped plane portion 232 of the upper housing 230 in which the lower end portion of the cover 100 is placed.

The outer circumferential surface of the extension portion 233 is arranged facing the inner circumferential surface of the lower end of the hemispherical cover 100. Accordingly, in the case in which the cover 100 is shaking in a certain direction by the external force applied to the cover 100 while the rotor 240 is rotating in the upper housing 230, the lower end portion of the cover 100 and the extension portion 233 are brought into contact with each other, and movement of the cover 100 is suppressed.

In other words, the cover 100 and the rotor 240 which is rotating may not be in contact with each other due to the extension portion 233 so that the cover 100 does not break and rotation of the rotor 240 is not obstructed. For such a reason, the centrifugal separation may stably continue.

The invention is not limited to the above-mentioned embodiments but may be embodied in various forms. The above-mentioned embodiments are provided to help ordinary skilled people better understand the scope of the invention. Accordingly, the scope of the invention must be understood from the following claims.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A centrifuging device comprising:
a housing having a safeguard structure for preventing a rotor and fractured pieces of rotor from spring out of the housing; and
a detachable cover which can be completely separated from the housing.

2. The centrifuging device according to claim 1, wherein the housing is composed of a lower housing and a middle housing accommodating a driving unit of a rotor therein, and an upper housing having a ring-shaped opening portion as a safeguard structure for preventing the rotor and the fractured pieces of the rotor from spring out of a housing, through which a upper portion of the rotor connected to the driving unit protrudes from an upper housing and a lower portion of the rotor can rotates in the upper housing.

3. The centrifuging device according to claim 1, wherein the cover can be attached to and detached from the upper housing by a plurality of magnets fixed to a lower end portion of the cover.

4. The centrifuging device according to claim 1, wherein the safeguard structure has a structure in which an inner diameter of an external circumferential plane portion of a ring-shaped opening portion of the upper housing is smaller than a diameter of a lower end portion of the rotor.

5. The centrifuging device according to claim 4, wherein the external circumferential plane portion of the ring-shaped opening is made of a metal.

6. The centrifuging device according to claim 5, wherein the upper housing has an extension portion extending upward from an inner edge of the ring-shaped plane portion of the upper housing and the extension portion has an internal circumferential surface corresponding to a surface of the rotor and an external circumferential surface corresponding to an internal circumferential surface of a lower end portion of the cover.

7. The centrifuging device according to claim 6, wherein the extension portion has a ring shape which is formed over the entire length of the inner edge of the ring-shaped plane portion.

8. The centrifuging device according to claim 6, wherein the extension portion is composed of unit pieces arranged along the entire length of the inner edge of the ring-shaped plane portion and the unit pieces are arranged having predetermined gaps therebetween.

9. The centrifuging device according to claim 2, wherein the cover can be attached to and detached from the upper housing by a plurality of magnets fixed to a lower end portion of the cover.

10. The centrifuging device according to claim 2, wherein the safeguard structure has a structure in which an inner diameter of an external circumferential plane portion of a ring-shaped opening portion of the upper housing is smaller than a diameter of a lower end portion of the rotor.

11. The centrifuging device according to claim 10, wherein the safeguard structure has a structure in which an inner diameter of an external circumferential plane portion of a ring-shaped opening portion of the upper housing is smaller than a diameter of a lower end portion of the rotor.
